(19) United States
(12) Patent Application Publication
(10) Pub. No.: US 2004/0246717 A1
(43) Pub. Date: Dec. 9, 2004

(54) Evacuation lighting system and associated method for using the same

(76) Inventor: Kirk Charles Campbell, Hudsonville, MI (US)

Correspondence Address: King & Jovanovic, PLC, 170 College Avenue, SUITE 230, HOLLAND, MI, 49423, US

(21) Appl. No.: 10/454,134

(22) Filed: Jun. 4, 2003

(51) Int. Cl. F21V 33/00

(52) U.S. Cl. 362/234; 362/227; 362/231; 362/251; 362/276; 362/802; 362/85; 362/236

(57) ABSTRACT

An evacuation lighting system comprising a plurality of lights, control circuitry and a power providing system. The lights comprise low voltage lights which are at least one of embedded in, and positioned proximate, a ground surface. The control circuitry is electrically coupled to the plurality of lights. The power providing system is electrically coupled to at least one of the control circuitry and the plurality of lights. The power providing system further comprises a UPS power supply, a grid power supply and a source switching circuitry capable of selecting one of the UPS power supply and the grid power supply. The control circuitry is capable of selectively controlling each of the plurality of lights, to, in turn, direct an individual in an evacuation. A method for using the same is likewise provided.

### BACKGROUND OF THE INVENTION

1. Field of the Invention

The present invention relates in general to lighting systems, and more particularly, to an evacuation lighting system and associated method for using the same. Such a system facilitates the efficient evacuation of various venues in the event of, for example, an emergency.

2. Background Art

Building safety and building evacuation is constantly undergoing scrutiny and increased development. For example, current codes require that exit signs be illuminated regardless of power failure, to indicate to those in a building the general direction of egress therefrom. While such advances have been incorporated into the National Electrical Code, efficient evacuation remains problematic for many venues—which can, often times, lead to chaos, injury and/or dramatically the loss of a human life.

For example, while exit signs are illuminated, in chaotic situations it is often difficult to recognize which exits are closest and which exits are inaccessible and/or dangerous. Moreover, it is very difficult to predict and control the movement of individuals to a particular exit. As such, individuals often proceed to an improper exit, or an exit which poses additional dangers. In addition, it is not uncommon for a large rush of individuals to proceed to a particular exit, thus overcrowding the exit, while other exits remain under-utilized. Furthermore, the exit signs often do not provide the individuals enough information as to the conditions on the opposing side of the exit, or a general overview of the emergency and/or crisis.

Accordingly, it is an object of the present invention to provide an evacuation lighting system that overcomes the deficiencies of the foregoing.

In particular, it is an object of the present invention to provide an evacuation lighting system which provides individuals with proper evacuation directions during an emergency and/or crisis.

It is yet another object of the invention to provide information to an individual, to, in turn, assist the same during an evacuation.

It is yet another object of the invention to provide a system which remains operational during power outages and the like.

These and other objects will become apparent in light of the present specification, claims, and drawings.

### SUMMARY OF THE INVENTION

The present invention is directed to an evacuation lighting system comprising a plurality of lights, control circuitry, and a power providing system. The lights comprise low voltage lights which are at least one of embedded in, and positioned proximate, a ground surface. The control circuitry is electrically coupled to the plurality of lights. The power providing system is electrically coupled to at least one of the control circuitry and the plurality of lights. The power providing system further comprises an uninterrupted power supply (herein after “UPS”), a grid power supply and source switching circuitry capable of selecting one of the UPS power supply and the grid power supply. The control circuitry is capable of selectively controlling each of the plurality of lights, to, in turn, direct an individual during an evacuation, emergency, crises, etcetera.

In a preferred embodiment of the present invention, the control circuitry is capable of controlling each of the plurality of lights individually.

In another preferred embodiment of the present invention, the control circuitry includes a communication link. The communication link is capable of communicating with at least one of a remotely positioned alarm system, sprinkler system, and monitoring system.

In another preferred embodiment of the present invention, the plurality of lights comprise a plurality of lights having at least two different colors. In one such preferred embodiment, the at least two different colors comprise at least two selected from the group consisting of: white, green and red.

Preferably, the UPS power supply is capable of providing power for at least 60% illumination for a period of at least one and a half hours.

In one preferred embodiment of the present invention, the source switching circuitry further includes circuitry for testing the operation of the UPS power supply.

In another preferred embodiment of the present invention, the control circuitry is capable of cascading the at least two lights.

The invention is also directed to a method of facilitating evacuation of an individual through at least one exit comprising the steps of: (a) providing a plurality of lights, wherein the lights comprise low voltage lights at least one of embedded in, and positioned proximate, a ground surface; (b) providing a control circuit, wherein the control circuit is capable of controlling the illumination of the plurality of lights; (c) providing a power source for the control circuit and the plurality of lights; (d) sensing an evacuation condition; (e) determining an illumination pattern by the control circuit; and (f) activating each of the plurality of lights in the illumination pattern, to, in turn, direct the individual through the at least one exit.

In one embodiment of the present invention, the step of sensing an evacuation condition further comprises the steps of: (a) linking the control circuit with at least one of an alarm system and a sprinkler system; and (b) receiving a evacuation signal from at least one of an alarm system and a sprinkler system.

In another embodiment of the present invention, the step of activating comprises the step of cascading the plurality of lights, to, in turn, direct the individual through the at least one exit.

In yet another embodiment of the present invention, the plurality of lights comprise a plurality of lights having at least two colors. In such an embodiment, the step of activating comprises the steps of: (a) illuminating a desired pathway in a first color; and (b) illuminating an undesired pathway in a second color.

In yet another embodiment of the present invention, the step of providing a power source comprises the steps of: (a) providing a source of grid power; (b) providing a UPS power supply; (c) providing a source switching circuit coupled to each of the source of grid power and the UPS power supply; and (d) selecting one of the source of grid power and the UPS power supply.

### BRIEF DESCRIPTION OF THE DRAWINGS

The invention will now be described with reference to the drawings wherein:

FIG. 1 of the drawings comprises a schematic representation of the evacuation lighting system of the present invention;

FIG. 2 of the drawings comprises a perspective view of a plurality of lights used in association with the evacuation lighting system of the present invention;

FIG. 3 of the drawings comprises a top plan view of an installation of the evacuation lighting system of the present invention; and

FIG. 4 of the drawings comprises a top plan view of another installation of the evacuation lighting system of the present invention.

### DETAILED DESCRIPTION OF THE INVENTION

While this invention is susceptible of embodiment in many different forms, there is shown in the drawings several specific embodiments with the understanding that the present disclosure is to be considered as an exemplification of the principles of the invention and is not intended to limit the invention to the embodiments illustrated.

It will be understood that like or analogous elements and/or components, referred to herein, are identified throughout the drawings by like reference characters. In addition, it will be understood that the drawings are merely representations of the present invention, and some of the components may have been distorted from actual scale for purposes of pictorial clarity.

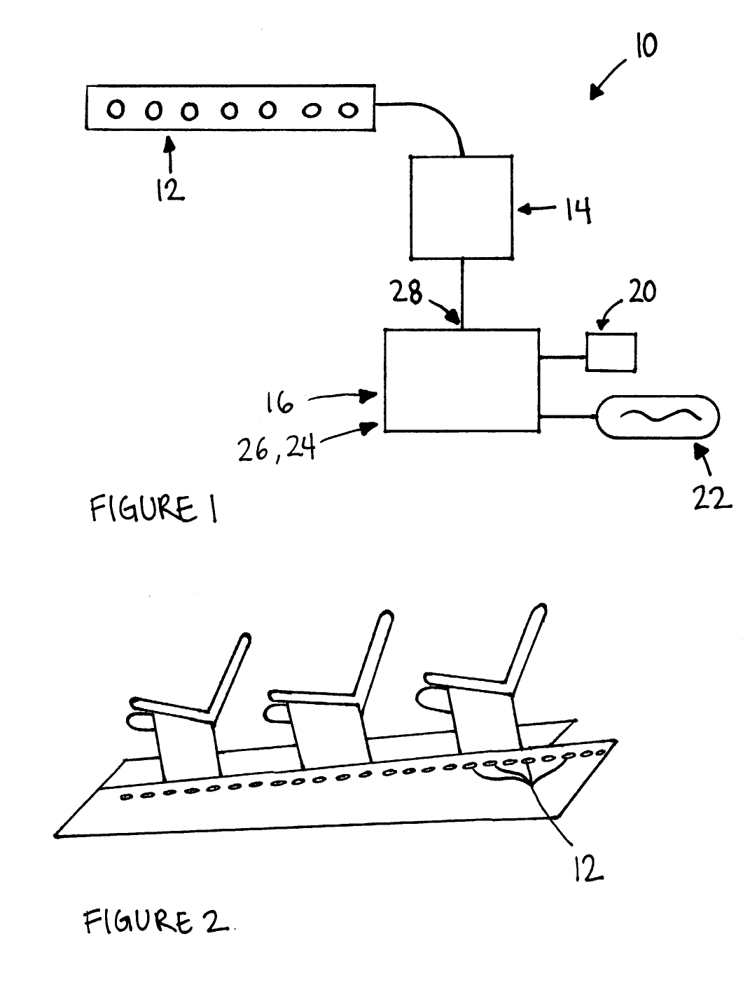

Referring now to the Figures, and in particular to FIG. 1, evacuation lighting system 10 is shown as comprising lights 12, control circuitry 14 and power providing system 16. It is contemplated that the evacuation lighting system can be utilized in theaters, exhibition halls, office buildings, hotels, churches, and the like. Indeed, the invention is not limited to any particular location of use.

Lights, such as lights 12 are shown in FIG. 1 as comprising a plurality of, preferably, low voltage incandescent lights, LED's, and fiber optic cables associated with remotely positioned light sources. Indeed, while low voltage lights exhibit certain distinct advantages, a number of different light sources are contemplated for use. Preferably, and as shown in FIG. 2, the lights are embedded along a walkway or otherwise positioned close to the ground so as to be particularly useful with illumination and identification, as well as providing individuals with a sense of the contours, distance and surface configurations of the surrounding ground surface. Additionally, the lights can be positioned strategically so as to direct individuals around, or warn individuals of, impending obstructions, such as stairs, ramps and the like.

As is shown in FIG. 1, the lights are associated with control circuitry 14 by way of wiring and cables. As will be explained, the control circuitry directs the individual lights to either an energized condition or to a de-energized condition. The control circuitry may comprise a microprocessor based controller, such as, for example, a computer and the like. The control circuitry may include non-volatile memory which can be programmed and reprogrammed as desired. Furthermore, a communications link may be provided so that remote communication and programming can be achieved, and, so that the control circuitry can be remotely monitored. Further still, the communications link can link the control circuitry with other systems of a particular location or venue (i.e. water sprinkler system, fire alarm system, etcetera).

Power providing system 16 is shown in FIG. 1 as comprising UPS power supply 20, grid power source 22, transformer 24, source switch circuitry 26 and output 28. The power providing system is electrically coupled with control circuitry 14, and, in turn, with lights 12. In certain embodiments, the power providing system may be functionally integrated with the control circuit, or may comprise a separate element. UPS power supply 20 comprises a self-contained power source, such as, for example, a primary or secondary battery (i.e., NiCad, NIMH, Li-ion, etcetera), and the like. Grid power source 22 generally comprises a connection to an outside AC source (i.e., city power supply). Transformers 24 are electrically coupled to the AC source to transform the AC source into a DC source for the low voltage lights.

Source switching circuitry 26 comprises a circuit which facilitates the switching of the system to and from the grid power source and the UPS power supply, to, in turn control the source supplying power to output 28. The source switching circuitry is capable of switching from grid power to UPS power supply power in the event of the loss of grid power, and, in turn, the switching from UPS power supply power to grid power when grid power is re-established. The source switching circuitry may include over current protection, indicators for the condition of the UPS power supply, UPS power supply testing circuitry and other user inputs and controls.

It is contemplated that the UPS power supply be rated to maintain the lights at 60% luminosity for an hour and a half. Moreover, if a dimming circuit is used by the location (as is the case with the lighting at most movie theaters), the source switching assembly may include an override for the dimming system, to insure that the appropriate and required level of illumination is achieved.

By programming the control circuitry, a number of different desirable operational configurations can be achieved through the use of the evacuation lighting system of the type described above. One such safety evacuation system is shown in the evacuation lighting system installation detailed in FIG. 3. In particular, lights, such as lights 12 are provided on the ground along each of the isles 100, 101, and 102, wherein the lights extend from seating areas to the exits, such as exits 104, 105, 106 and 107. The lights are associated with the control circuitry such that the control circuitry can control each individual light, or, at least, small groups of lights. Such control of the lighting permits sequential, toggled and/or patterned illumination of the lights.

Advantageously, for example, in the event of an evacuation, the control system can be prompted to cascade or otherwise toggle the lights on and off to direct individuals to desired isles and then along the desired isles to desired exits.

Further advantages are realized by associating the control circuitry with a remote fire alarm system or sprinkler system via a communication link. In particular, a remote alarm system or sprinkler system can warn of impending danger and the location of such danger. In turn, the control circuitry can compute the most appropriate direction for the evacuation of an area. In turn, lights can be toggled on and/or off to direct individuals away from dangerous exits and toward safe exits.

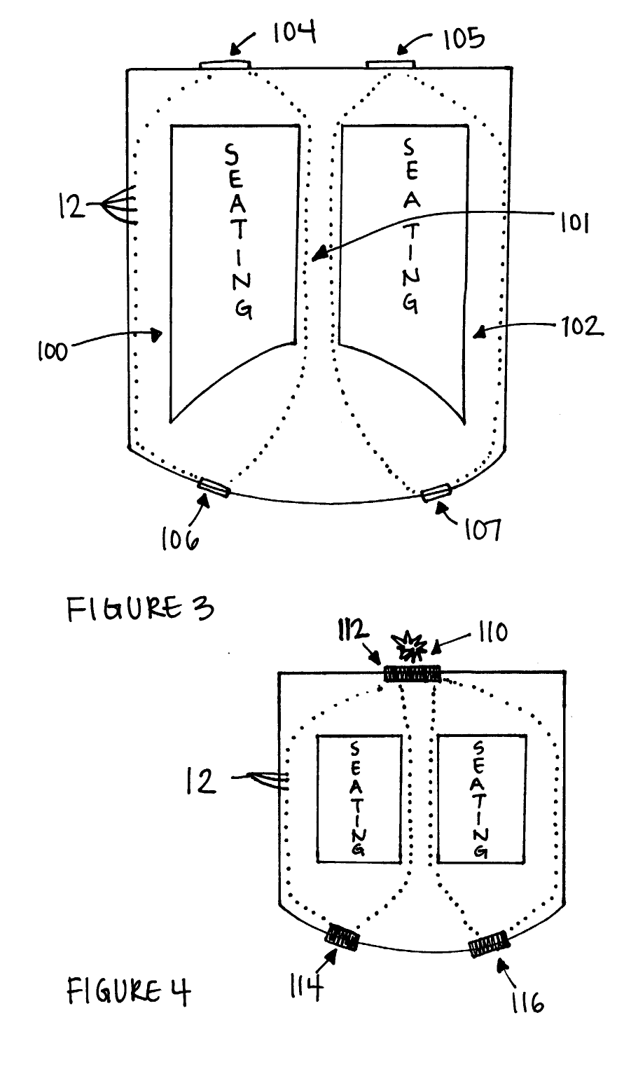

In another embodiment, instead of toggling the lights on and/or off, the lights may include several different colors, such as, for example, yellow, green, red, blue, white, among others. For example, in case of an evacuation, green lights can be activated in a pre-determined pattern to illuminate a safe passage to an exit, whereas red lights can be activated in a pre-determined pattern to illuminate unsafe areas or unsafe regions. Such an installation of an evacuation lighting system is detailed in FIG. 4. In particular, an undesirable condition 110 exists proximate exit 112. In turn, lights directing individuals to exit 112 are illuminated red, whereas the lights directing individuals to exits 114 and 116 remain illuminated green (and may be toggled, or, cascaded, as explained above).

Of course, other illumination techniques can be utilized through the programming of the control system to control the illumination of the lights.

The foregoing description merely explains and illustrates the invention and the invention is not limited thereto except insofar as the appended claims are so limited, as those skilled in the art who have the disclosure before them will be able to make modifications without departing the scope of the invention.

What is claimed is:

1. An evacuation lighting system, comprising:
a plurality of lights, wherein the lights comprise low voltage lights at least one of embedded in, and positioned proximate, a ground surface;
a control circuitry electrically coupled to the plurality of lights;
a power providing system electrically coupled to at least one of the control circuitry and the plurality of lights, wherein the power providing system further comprising a UPS power supply, a grid power supply and a source switching circuitry capable of selecting one of the UPS power supply and the grid power supply; and
wherein the control circuitry is capable of selectively controlling each of the plurality of lights, to, in turn, direct an individual in an evacuation.

2. The evacuation lighting system according to claim 1, wherein the control circuitry is capable of controlling each of the plurality of lights individually.

3. The evacuation lighting system according to claim 1, wherein the control circuitry includes a communication link, wherein the communication link is capable of communicating with at least one of a remotely positioned alarm system, sprinkler system and monitoring system.

4. The evacuation lighting system according to claim 1, wherein the plurality of lights comprise a plurality of lights in at least two different colors.

5. The evacuation lighting system according to claim 4, wherein the at least two different colors comprise at least two selected from the group consisting of white, green and red.

6. The evacuation lighting system according to claim 1, wherein the UPS power supply is capable of providing power for at least 60% illumination for a period of at least one and a half hours.

7. The evacuation lighting system according to claim 1, wherein the source switching circuitry further includes circuitry for testing the operation of the UPS power supply.

8. The evacuation lighting system according to claim 1, wherein the control circuitry is capable of cascading the at least two lights.

9. A method of facilitating evacuation of an individual through at least one exit, comprising the steps of:
providing a plurality of lights, wherein the lights comprise low voltage lights at least one of embedded in, and positioned proximate, a ground surface;
providing a control circuit, the control circuit capable of controlling the illumination of the plurality of lights;
providing a power source for the control circuit and the plurality of lights;
sensing an evacuation condition;
determining an illumination pattern by the control circuit; and
activating each of the plurality of lights in the illumination pattern, to, in turn, direct the individual through the at least one exit.

10. The method according to claim 9, wherein the step of sensing an evacuation condition further comprises the steps of:
linking the control circuit with at least one of an alarm system and a sprinkler system; and
receiving an evacuation signal from at least one of an alarm system and a sprinkler system.

11. The method according to claim 9, wherein the step of activating comprises the step of: cascading the plurality of lights, to, in turn, direct the individual through the at least one exit.

12. The method according to claim 9, wherein the plurality of lights comprise a plurality of lights in at least two colors, the step of activating comprises the steps of:
illuminating a desired pathway in a first color; and
illuminating an undesired pathway in a second color.

13. The method according to claim 9, wherein the step of providing a power source comprises the steps of:
providing a source of grid power;
providing a UPS power supply;
providing a source switching circuit coupled to each of the source of grid power and the UPS power supply; and
selecting one of the source of grid power and the UPS power supply.
